(19) United States
(12) Patent Application Publication
(10) Pub. No.: US 2005/0208289 A1
(43) Pub. Date: Sep. 22, 2005

(54) Polystyrene foam article having a coating and a method for producing the same

(76) Inventors: Ronald G. Gabbard, North Brunswick, NJ (US); Robert D. Ober, Pineville, NC (US); Christine Morey, Somerset, NJ (US); Grace X. Chang, Washington, DC (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/804,437

(22) Filed: Mar. 19, 2004

(51) Int. Cl. B32B 3/06; C08J 9/22; B32B 3/26

(52) U.S. Cl. 428/306.6; 428/304.4; 428/313.3

(57) ABSTRACT

A polystyrene foam article and methods for producing the polystyrene foam article having a coating for reducing abrasiveness are disclosed. The reduced abrasiveness prevents scratching of surfaces in direct contact with the polystyrene foam article. The coating is applied to either a second surface area of an expanded polystyrene bead or an outer surface area of the polystyrene foam article. The coating may be any polymeric wax that reduces the abrasiveness of the polystyrene foam article.

### BACKGROUND OF THE INVENTION

1. Field of the Invention

The subject invention relates to a polystyrene foam article, and methods for producing an expanded polystyrene bead and for producing the polystyrene foam article.

2. Description of the Related Art

Expandable polystyrene beads, polystyrene foam articles, and methods for producing the expandable polystyrene beads and the polystyrene foam articles are known in the art. Such polystyrene foam articles are produced from a plurality of expanded polystyrene bead. Expanded polystyrene beads are produced from the expandable polystyrene beads, which are formed from a mixture of polystyrene and a blowing agent. The expandable polystyrene beads are generally formed in an aqueous suspension polymerization reaction. The blowing agent is introduced into the expandable polystyrene beads either during or after the polymerization reaction. The blowing agent is homogeneously dispersed within the polystyrene. The blowing agent is a hydrocarbon blowing agent, which is gaseous or liquid under normal conditions and which does not dissolve the expandable polystyrene beads and is not soluble in the expandable polystyrene beads. Generally, the expandable polystyrene beads are initially of relatively small size having a diameter of from about 0.2 to 4 millimeters. In addition, the boiling point T_{b} of the blowing agent is below the glass transition temperature T_{g} of the expandable polystyrene beads such that upon heating of the expandable polystyrene beads the blowing agent vaporizes. Some of the blowing agent leaves the expandable polystyrene beads, thereby expanding the expandable polystyrene beads.

Typically, the expandable polystyrene beads are expanded to form expanded polystyrene beads. This step includes heating the expandable polystyrene beads to a temperature above the glass transition temperature T_{g} of the expandable polystyrene beads and above the boiling point T_{b} of the blowing agent, resulting in vaporization of the blowing agent and expansion of the expandable polystyrene beads to form the expanded polystyrene beads. The expanded polystyrene beads are quite fragile and, as a second step, it is generally necessary to allow the expanded polystyrene beads to age for a period of time to make the expanded polystyrene beads less fragile. To age the expanded polystyrene beads, the expanded polystyrene beads are maintained under a normal atmosphere for a sufficient amount of time. The aging process may range from a few minutes to hours. The aging process may occur at any time period from the end of the expansion step to placing the expanded polystyrene beads in a mold. During the aging process, air from outside of the expanded polystyrene beads diffuses into the expanded polystyrene beads. If aged for an extended period of time, generally for at least four hours, blowing agent within the expanded polystyrene beads begins to diffuse out of the expanded polystyrene beads. Once the expanded polystyrene beads have aged, they can be placed in the mold and heated again such that the expanded polystyrene beads further expand to fill a space in the mold and fuse to each other to form the polystyrene foam article. The polystyrene foam article can either be a large block, which is subsequently cut with a hot wire cutter into sheets or other shapes, or the polystyrene foam article can be a particular shape.

One problem encountered in the prior art methods for producing the expandable polystyrene beads is lumping of the expandable polystyrene beads during expansion. In an attempt to control this lumping phenomenon, a number of external coatings have been applied to the expandable polystyrene beads prior to or during expansion. Some examples of commonly used external coatings include zinc stearate, glycerol mono stearate, ethylene-bis stearamide, silica, and block copolymer of propylene oxide and ethylene oxide. Such external coatings are applied to a first surface area of the expandable polystyrene beads before or during expansion to be effective in preventing lumping of the expanded polystyrene beads. The first surface area is a surface of the expandable polystyrene beads before expansion.

However, the polystyrene foam articles of the prior art are not suitable for applications in which the polystyrene foam articles are used in direct contact with packaged products having colored, glossy, or painted surfaces. Expansion of the expandable polystyrene beads produces expanded polystyrene beads having a second surface area that is significantly greater than the first surface area. Thus, any coating applied to the expandable polystyrene beads prior to or during expanding does little to alter physical properties of the second surface area. The resulting polystyrene foam articles have an exposed surface area that is not covered by any coating whatsoever. As such, the polystyrene foam articles of the prior art are abrasive and scratch the colored, glossy, or painted surfaces, regardless of any coating added prior to or during expanding the expandable polystyrene beads. To counteract this problem, the products are placed in plastic bags before packaging with the polystyrene foam articles. The plastic bags increase costs for such packaging applications.

Thus, it would be advantageous to provide a polystyrene foam article and expanded polystyrene beads that have complete and adequate coating on the second surface area to reduce abrasiveness, thereby eliminating the need for the plastic bags for use to package products having colored, glossy, or painted surfaces without damaging the colored, glossy, or painted surfaces.

### SUMMARY OF THE INVENTION AND ADVANTAGES

The subject invention provides a method for producing an expanded polystyrene bead, a polystyrene foam article, and a method for producing the polystyrene foam article. The polystyrene foam article includes a coating to reduce abrasiveness and prevent scratching of surfaces in direct contact with the polystyrene foam article.

In the method for producing the expanded polystyrene bead, an expandable polystyrene bead is provided. The expandable polystyrene bead has a first surface area and includes polystyrene and at least one blowing agent. The expandable polystyrene bead is expanded to produce the expanded polystyrene bead having a second surface area that is greater than the first surface area. The coating is applied to the second surface area of the expanded polystyrene bead. This coating reduces the abrasiveness of the expanded polystyrene bead and prevents scratching of surfaces in direct contact with the polystyrene foam article.

In the method for producing the polystyrene foam article, a plurality of expandable polystyrene beads are expanded to produce the plurality of expanded polystyrene beads having a second surface area greater than the first surface area. The plurality of expanded polystyrene beads are then aged. Next, the plurality of expanded polystyrene beads are placed in a mold. The plurality of expanded polystyrene beads are then fused together to produce the polystyrene foam article having an outer surface area. The polystyrene foam article is removed from the mold. The coating is applied to at least one of the second surface area of the plurality of expanded polystyrene beads and the outer surface area of the polystyrene foam article to reduce the abrasiveness of the polystyrene foam article and to prevent scratching of surfaces in direct contact therewith.

Thus, the subject invention provides the polystyrene foam article, the method for producing the polystyrene foam article, and the method for producing the expanded polystyrene bead having reduced abrasiveness for use to package products without scratching colored, glossy, or painted surfaces in direct contact with the polystyrene foam article. Furthermore, the subject invention simplifies packaging applications by eliminating the use of plastic bags.

### DETAILED DESCRIPTION OF A PREFERRED EMBODIMENT

The subject invention provides a method for producing an expanded polystyrene bead having a coating to reduce abrasiveness and prevent scratching of surfaces in direct contact therewith. The subject invention further provides a polystyrene foam article and a method for producing the polystyrene foam article having the coating. As described immediately above, the coating reduces abrasiveness and prevents scratching of surfaces in direct contact therewith.

The method for producing the expanded polystyrene bead includes the step of providing the expandable polystyrene bead having a first surface area. The expandable polystyrene bead is generally formed via an aqueous suspension polymerization reaction, wherein a monomer or monomers are polymerized to form polystyrene or copolymers of polystyrene. The polystyrene is combined with at least one blowing agent and other additives to form the expandable polystyrene bead.

In the aqueous suspension polymerization reaction, the monomers used to form the polystyrene include styrene or styrene derivatives. Examples of styrene derivatives include α-methylstyrene, o-methylstyrene, m-methylstyrene, p-methylstyrene, ethylstyrene, vinylxylene, chlorostyrene, and bromostyrene. These styrene derivatives may include minor amounts of divinylbenzene, methylmethacrylate, or acrylonitrile. The preferred monomer is styrene. The monomers are suspended in an aqueous solution and polymerized. Generally, the blowing agent is added during the aqueous suspension polymerization reaction, but may be added during later processing steps.

Blowing agents suitable for the present invention generally include C₃-C₆ hydrocarbons and mixtures thereof, with pentane isomers being preferred. However, a variety of blowing agents may be used. Preferably, the blowing agent has a boiling point T_{b} below that of the glass transition temperature T_{g} of the expandable polystyrene bead such that upon heating of the expandable polystyrene bead the blowing agent vaporizes and leaves the expandable polystyrene bead, thereby expanding the expandable polystyrene bead. Preferably, the boiling point T_{b} is no greater than 70° C. Suitable blowing agents include, for example, propane, butane, isobutane, n-pentane, isopentane, neopentane, cyclopentane, methylcyclopentane, 2-methyl pentane, 3-methyl pentane, 2,2-dimethylbutane, 2,3-dimethylbutane, pentane petroleum distillate fractions, hexane, cyclohexane, methylcyclohexane, and hexane isomers. Blowing agents are generally used at levels of from 2.0 to 8.0 weight percent, more preferably at 3.0 to 6.5 weight percent based on the total weight of the expandable polystyrene bead.

The aqueous suspension polymerization reaction may also utilize chain transfer agents, suspension stabilizers, and polymerization initiators. A typical chain transfer agent is dimeric to-methylstyrene. Common suspension stabilizers include molecular colloids, such as polyvinyl alcohol (PVA) and polyvinyl pyrrolidone (PVP), and pickering salts, such as Ca₃(PO₄)₂, in combination with an extender such as dodecylbenzol sulfate. Typical polymerization initiators include radical initiators such as dibenzoylperoxide, tert-butyl perbenzoate, and dicumyl peroxide. Other suitable polymerization initiators are known to those of ordinary skill in the art.

The expandable polystyrene bead may also include other additives like flame retardants based on organic bromo or chloro compounds, such as, tris(dibromopropyl) phosphate, hexabromocyclododecane, chloroparaffin. Other additives include antistatic agents, stabilizers, dyes, lubricants, and fillers. To aid in removing the polystyrene foam article from a mold after being molded, compounds such as glycerine ester and hydroxycarboxylic acid ester may also be included.

After the aqueous suspension polymerization reaction, the expandable polystyrene bead is separated from the aqueous portion of the suspension, washed and dried. The step of drying the expandable polystyrene bead includes processing the plurality of expandable polystyrene beads in a screw conveyor that feeds a heated airveyor for flash drying. At this point, an anti-lumping agent may be added to the first surface area to prevent lumping of the expandable polystyrene beads during the later step of expansion. The anti-lumping agent is generally at least one of zinc stearate, glycerol mono stearate, ethylene-bis stearamide, silica, and a block copolymer of propylene oxide and ethylene oxide. Once dried, the expandable polystyrene beads are sized into fractions. The expandable polystyrene beads generally have a diameter of from 0.2 to 4.0 mm. Alternatively, the anti-lumping agent may be added to a powder blending system after sizing the expandable polystyrene beads. These blending systems typically include a plow blade mixer such as the Littleford FKM mixers. The anti-lumping agent and other additives are combined with the expandable polystyrene beads and mixed using a plow blade mixer.

In the expansion step, the expandable polystyrene bead is expanded to produce the expanded polystyrene bead. Preferably, the expandable polystyrene bead is heated, usually via steam, to a temperature above the boiling point T_{b} of the blowing agent and a temperature of at least the glass transition temperature T_{g} of the expandable polystyrene bead. The boiling point T_{b} is preferably no greater than 70° C. This heating causes the blowing agent to vaporize and the polystyrene to become pliable, which results in expansion of the expandable polystyrene bead into the expanded polystyrene bead having a second surface area that is 4 to 16 times greater than the first surface area. At this point, the anti-lumping agent no longer sufficiently covers the expanded polystyrene bead, specifically the second surface area of the expanded polystyrene bead.

The expansion of the expandable polystyrene bead is generally carried out in a closed vessel batch expander with a steam injection process. Typical examples of such expanders include: Kurtz VSD1000 and Hirsch 6000. The expandable polystyrene bead may also be expanded in a continuous expander. The expandable polystyrene bead is passed through the expander and is heated to vaporize the blowing agent and to make the polystyrene pliable, thereby expanding the expandable polystyrene bead. The flow rate of the expandable polystyrene bead through the expander determines the amount of expansion and it is generally reported as pounds per cubic foot of expanded polystyrene bead, or for a given expander, as pounds per hour.

After expanding, the expanded polystyrene bead is fragile and is thus susceptible to being damaged through additional processing. To make the expanded polystyrene bead less fragile, the expanded polystyrene bead is preferably placed into a mesh bag in preparation for an aging step. In the aging step, the expanded polystyrene bead is allowed to age for a sufficient period of time, preferably for at least 4 hours, to become less fragile. During the aging step, external air diffuses into the expanded polystyrene bead and some residual blowing agent diffuses out of the expanded polystyrene bead. After the aging step, the expanded polystyrene bead is sufficiently less fragile such that the expanded polystyrene bead is no longer susceptible to damage through additional processing.

In the molding step, the expanded polystyrene bead is placed into a mold after the aging step. Preferably, the mold is a closed mold, however the mold may be of a variety of different types. The expanded polystyrene bead is heated again. Residual blowing agent in the expanded polystyrene bead further expands the expanded polystyrene bead to form the polystyrene foam article having an outer surface area. A significantly lower amount of blowing agent is in the expanded polystyrene bead prior to molding than prior to the expansion step. Thus, the expansion of the expanded polystyrene bead in the mold is less dramatic than the expansion of the expandable polystyrene bead in the expansion step. The polystyrene foam article may be a block or a more complex shape. After the molding step, the polystyrene foam article is removed from the mold and cooled.

In a coating step, the coating is applied to the second surface area to reduce the abrasiveness of the expanded polystyrene bead. The reduced abrasiveness prevents scratching of surfaces in direct contact with the second surface area. The coating step occurs after the expansion step due to the increase in surface area of the expandable polystyrene bead during the expansion step. The coating is applied to at least one of the second surface area of the expanded polystyrene bead and the outer surface area of the polystyrene foam article to sufficiently reduce the abrasiveness of the polystyrene foam article. The coating may be applied to the second surface area and still sufficiently reduce the abrasiveness of the polystyrene foam article due to less dramatic expansion of the expanded polystyrene bead during the molding step than in the expansion step.

The coating may be any polymeric wax that reduces abrasiveness of the polystyrene foam article. Preferably, the polymeric wax is formed from monomers having from 1 to 8 carbon atoms. More preferably, the polymeric wax formed from monomers having from 1 to 8 carbon atoms is a polyethylene wax having a molecular weight of from 450 to 3000, more preferably having a molecular weight of 1000. The polyethylene wax is preferably Polywax®, manufactured by Baker Petrolite, a division of Baker Hughes Incorporated, a Delaware corporation.

The coating is preferably applied in an aqueous dispersion of the polymeric wax. The aqueous dispersion contains an aqueous portion and a polymeric wax portion. The aqueous portion is water, but may also be any other solvent that will not dissolve the polymeric wax or the polystyrene foam article. Other forms of the polymeric wax are available, however the aqueous dispersion of the polymeric wax provides superb flexibility of application. For example, the aqueous dispersion of the polymeric wax is sprayed onto at least one of the second surface area and the outer surface area, but may also be applied by other mixing techniques such as mixing the aqueous dispersion of the polymeric wax with at least one of the expanded polystyrene bead and polystyrene foam article in a mixer or dipping at least one of the expanded polystyrene bead and the polystyrene foam article into a vat containing the aqueous dispersion of the polymeric wax.

A volatile portion, including the aqueous portion of the aqueous dispersion of the polymeric wax along with any other volatile materials, is dried off of the second surface area. When the coating is applied prior to molding the expanded polystyrene bead, the volatile portion is dried off of the second surface area when the expanded polystyrene bead is heated during the molding step. In another embodiment, the aqueous dispersion is applied to the outer surface area after the polystyrene foam article is removed from the mold. In a separate drying step, the volatile portion is dried off of the outer surface area. Drying is performed by heating the polystyrene foam article to a drying temperature range T_{D} of 40-50° C. and maintaining the polystyrene foam article in that drying temperature range T_{D} for a sufficient period of time. The drying temperature range T_{D} is below the glass transition temperature T_{g} of the expandable polystyrene bead and below a melting temperature Tₘ of the polymeric wax to prevent deformation of the polystyrene foam article.

In another embodiment, a plurality of expandable polystyrene beads are expanded in the expansion step to produce a plurality of expanded polystyrene beads. The plurality of expanded polystyrene beads are aged in accordance with the aging step as previously set forth. The plurality of expanded polystyrene beads are place in the mold after the aging step to produce the polystyrene foam article.

In a fusing step, the plurality of expanded polystyrene beads are heated again. Residual blowing agent in the plurality of expanded polystyrene beads further expands the plurality of expanded polystyrene beads. The plurality of expanded polystyrene beads expand into each other and fuse together to produce the polystyrene foam article having the outer surface area. A significantly lower amount of blowing agent is in the plurality of expanded polystyrene beads prior to molding than prior to the expansion step. Thus, the expansion of the plurality of expanded polystyrene beads in the mold is less dramatic than the expansion of the plurality of expandable polystyrene beads in the expansion step. The polystyrene foam article may be a block or a more complex shape. After the molding step, the polystyrene foam article is removed from the mold and cooled. The coating and the coating step is identical to the coating and coating step as previously set forth to reduce the abrasiveness of the polystyrene foam article and prevent scratching of surfaces in direct contact with the polystyrene foam article.

### EXAMPLES

TABLE 1

| | Relative Weight |
|---|---|
| Material | Increase/Decrease |
| Expanded Polystyrene of the | Decrease |
| Subject Invention | |
| Polyethylene Bag (Prior Art) | Increase |
| Expanded Polypropylene | Increase |
| (Prior Art) | |
| Expanded Polystyrene | Increase |
| (Prior Art) | |

Referring to Table 1, polystyrene foam articles of the subject invention were prepared for performing comparative testing in relation to common packaging materials including polyethylene bags and both expanded polypropylene and expanded polystyrene articles that were not surface treated with a polyethylene wax. The comparative testing included weight measurement comparisons between the various articles before and after subjecting the articles to ASTM testing procedure D5264 (modified) Volume 15.09. As known to those skilled in the art, ASTM D5264 (modified) is a testing procedure for abrasion resistance of printed materials, more specifically, applied graphics on a flat surface, by a Sutherland Rub Tester. Thus, the ASTM D5264 (modified) test procedure is useful in determining an amount of damage that the various articles inflict on packaged products having the applied graphics on the flat surface.

The abrasiveness of the articles is measured in terms of a weight increase or weight decrease of the articles after rubbing the flat surfaces of the packaged products with the articles. More specifically, the articles and the flat surfaces of the packaged products are subjected to 300 strokes, after which the relative increase or decrease in the weight of the articles is measured. A decrease in weight of the articles indicates that the product surfaces are abrading the articles, and thus the articles that indicate a decrease in weight are less abrasive than articles that result in a weight increase or no change in weight. The polyethylene bag and both the expanded polypropylene and the expanded polystyrene articles that were not surface treated with the polyethylene wax exhibited an increase in weight after testing. The polystyrene foam article of the subject invention, which are coated with the polyethylene wax, exhibited a decrease in weight after testing, representing a reduction in abrasiveness over the polyethylene bag and both the expanded polypropylene and the expanded polystyrene articles that were not surface treated with the polyethylene wax.

Obviously, many modifications and variations of the present invention are possible in light of the above teachings. The invention may be practiced otherwise than as specifically described within the scope of the appended claims.

1. A method for producing an expanded polystyrene bead having a coating, said method comprising the steps of:
providing an expandable polystyrene bead having a first surface area and including polystyrene and at least one blowing agent;
expanding the expandable polystyrene bead to produce the expanded polystyrene bead having a second surface area that is greater than the first surface area; and
applying a coating to the second surface area to reduce the abrasiveness of the expanded polystyrene bead.

2. A method as set forth in claim 1 wherein the coating comprises a polymeric wax.

3. A method as set forth in claim 2 wherein the polymeric wax comprises a polymeric wax formed from monomers having from 1 to 8 carbon atoms.

4. A method as set forth in claim 3 wherein the polymeric wax formed from monomers having from 1 to 8 carbon atoms comprises a polyethylene wax.

5. A method as set forth in claim 1 wherein the coating comprises an aqueous dispersion of a polymeric wax.

6. A method as set forth in claim 1 wherein said step of applying the coating to the second surface area comprises spraying the coating on the second surface area.

7. A method as set forth in claim 1 wherein said step of applying the coating to the second surface area comprises mixing the coating with the expanded polystyrene bead in a mixing apparatus.

8. A method as set forth in claim 1 wherein the expandable polystyrene bead has a glass transition temperature T_{g} and the blowing agent has a boiling point T_{b} and said step of expanding the expandable polystyrene bead comprises expanding the expandable polystyrene bead at a temperature of at least the boiling point T_{b} of the blowing agent and at a temperature of at least the glass transition temperature T_{g} of the expandable polystyrene bead.

9. A method as set forth in claim 1 further comprising the step of placing the expanded polystyrene bead in a mesh bag.

10. A method as set forth in claim 9 further comprising the step of aging the expanded polystyrene bead in the mesh bag such that the blowing agent diffuses out of the expanded polystyrene bead and air diffuses into the expanded polystyrene bead.

11. A method as set forth in claim 1 further comprising the step of aging the expanded polystyrene bead in an ambient temperature range for a period of at least 4 hours such that the blowing agent diffuses out of the expanded polystyrene bead and air diffuses into the expanded polystyrene bead.

12. A method for producing a polystyrene foam article wherein the polystyrene foam article includes a plurality of expanded polystyrene beads formed from a plurality of expandable polystyrene beads that include polystyrene and at least one blowing agent, said method comprising the steps of:
expanding the plurality of expandable polystyrene beads having a first surface area to produce the plurality of expanded polystyrene beads having a second surface area greater than the first surface area;
aging the plurality of expanded polystyrene beads;
placing the plurality of expanded polystyrene beads in a mold;
fusing the plurality of expanded polystyrene beads together to produce the polystyrene foam article having an outer surface area;
removing the polystyrene foam article from the mold; and
applying a coating to at least one of the second surface area of the plurality of expanded polystyrene beads and the outer surface area of the polystyrene foam article to reduce the abrasiveness of the polystyrene foam article.

13. A method as set forth in claim 12 wherein the coating comprises a polymeric wax.

14. A method as set forth in claim 13 wherein the polymeric wax comprises a polymeric wax formed from monomers having from 1 to 8 carbon atoms.

15. A method as set forth in claim 14 wherein the polymeric wax formed from monomers having from 1 to 8 carbon atoms comprises a polyethylene wax.

16. A method as set forth in claim 12 wherein the coating comprises an aqueous dispersion of a polymeric wax.

17. A method as set forth in claim 12 wherein said step of applying the coating comprises spraying the coating on at least one of the second surface area of the plurality of expanded polystyrene beads and the outer surface area of the polystyrene foam article.

18. A method as set forth in claim 12 wherein said step of applying the coating comprises mixing the coating with at least one of the plurality of expanded polystyrene beads and the polystyrene foam article in a mixing apparatus.

19. A method as set forth in claim 12 wherein said step of applying the coating comprises applying the coating to the outer surface area of the polystyrene foam article after said step of fusing the plurality of expandable polystyrene beads.

20. A method as set forth in claim 19 further comprising the step of drying a volatile portion of the coating from the outer surface area of the polystyrene foam article after said step of applying the coating.

21. A method as set forth in claim 20 wherein said step of drying comprises drying the volatile portion of the coating from the outer surface area of the polystyrene foam article in a drying temperature range of between 40 and 50° C.

22. A method as set forth in claim 12 wherein said step of applying the coating comprises applying the coating to the second surface area of the plurality of expanded polystyrene beads before said step of fusing the plurality of expandable polystyrene beads.

23. A method as set forth in claim 12 wherein the plurality of expandable polystyrene beads have a glass transition temperature T_{g} and the blowing agent has a boiling point T_{b} and said step of expanding the plurality of expandable polystyrene beads comprises expanding the plurality of expandable polystyrene beads at a temperature of at least the boiling point T_{b} of the blowing agent and at a temperature of at least the glass transition temperature T_{g} of the expanded polystyrene beads to produce the plurality of expanded polystyrene beads.

24. A method as set forth in claim 12 further comprising the step of placing the plurality of expanded polystyrene beads in a mesh bag.

25. A method as set forth in claim 24 further comprising the step of aging the plurality of expanded polystyrene beads in the mesh bag such that the blowing agent diffuses out of the plurality of expanded polystyrene bead and air diffuses into the plurality of expanded polystyrene beads.

26. A method as set forth in claim 12 wherein said step of aging the plurality of expanded polystyrene beads comprises aging the plurality of expanded polystyrene beads in an ambient temperature range for a period of at least 4 hours such that the blowing agent diffuses out of the plurality of expanded polystyrene beads and air diffuses into the plurality of expanded polystyrene beads.

27. A method as set forth in claim 12 wherein the mold is a closed mold and said step of fusing the plurality of expanded polystyrene beads comprises fusing the plurality of expanded polystyrene beads in the closed mold.

28. A polystyrene foam article having reduced abrasiveness, said article comprising:
an expanded polystyrene surface area formed from the expansion of an expandable polystyrene bead containing a blowing agent; and
a coating applied to said expanded surface area.

29. A polystyrene foam article as set forth in claim 28 wherein said coating comprises as a polymeric wax.

30. A polystyrene foam article as set forth in claim 29 wherein said polymeric wax comprises a polymeric wax formed from monomers having from 1 to 8 carbon atoms.

31. A polystyrene foam article as set forth in claim 30 wherein said polymeric wax formed from monomers having from 1 to 8 carbon atoms comprises a polyethylene wax.

32. A polystyrene foam article as set forth in claim 28 wherein said coating comprises an aqueous dispersion of a polymeric wax.

33. A polystyrene foam article as set forth in claim 28 wherein said polystyrene foam article is formed from a plurality of expanded polystyrene beads comprising polystyrene and at least one blowing agent.

34. A polystyrene foam article as set forth in claim 33 wherein said blowing agent comprises a C₃ to C₆ hydrocarbon blowing agent.

35. A polystyrene foam article as set forth in claim 28 wherein the polystyrene foam article exhibits a reduction in weight after subjected to ASTM method D5264.
